(19) United States
(12) Patent Application Publication
(10) Pub. No.: US 2026/0211723 A1
(43) Pub. Date: Jul. 23, 2026

(54) METHOD FOR TASK SCHEDULING AND VERIFICATION FOR ARTIFICIAL INTELLIGENCE MODELS AND COMPUTING DEVICE OPERATING THE SAME

(71) Applicant: Vessl Al Korea Inc., Gwangju (KR)

(72) Inventors: Seok Ju HONG, Seoul (KR); Min Kyu KIM, Seongnam-si (KR); Gi Sung PARK, Yongin-si (KR); Yong Seon LEE, Seoul (KR); Hyun Su LIM, Seoul (KR)

(21) Appl. No.: 19/272,143

(22) Filed: Jul. 17, 2025

(30) Foreign Application Priority Data
Jan. 23, 2025 (KR) 10-2025-0010086

(51) Int. Cl. G06F 9/48; G06F 9/50

(52) U.S. Cl. CPC G06F 9/4881; G06F 9/5061; G06F 2209/501

(57) ABSTRACT

A method for task scheduling and verification for an artificial intelligence model includes generating a task graph for a first pipeline of the artificial intelligence model, the task graph including a plurality of nodes and at least one edge, verifying the task graph, based on the plurality of nodes and the at least one edge, scheduling at least one first workload corresponding to a non-dependent node by using a topological sort algorithm, when the task graph is verified, executing the at least one first workload, scheduling at least one second workload corresponding to a node where dependency with the at least one first workload is released, executing the at least one second workload, and deploying the artificial intelligence model to a user device when all of a plurality of workloads corresponding to the plurality of nodes included in the task graph are performed.

### CROSS-REFERENCE TO RELATED APPLICATIONS

This application claims priority under 35 U.S.C. § 119 to Korean Patent Application No. 10-2025-0010086 filed on Jan. 23, 2025, in the Korean Intellectual Property Office, the disclosures of which are incorporated by reference herein in their entireties.

### BACKGROUND

Embodiments of the present disclosure described herein relate to a method for task scheduling and verification for an artificial intelligence model and a computing device performing the same, and more particularly, relate to a method for task scheduling and verification for an artificial intelligence model for automating verification of an artificial intelligence model and implementing a pipeline system of a learning process of the artificial intelligence model and a computing device performing the same.

Machine learning (ML) and artificial intelligence (AI) technologies are developing day by day and are reaching a level where the ML and AI technologies are capable of being commercialized. To commercialize an artificial intelligence model, the use of complex techniques such as fine tuning and evaluation of the artificial intelligence model is being required. After the artificial intelligence model is tuned and evaluated, the model is again tuned depending on the evaluation result, or a task such as tuned model production environment deployment of an inference server is performed so as to be used by the user.

Organically linked tasks are required to allow the user to finally use the artificial intelligence model. When a small mistake occurs while performing the linked tasks, the small mistake affects a subsequent work; due to the characteristics of machine learning works, the mistake in the previous work causes an increase in GPU usage costs and temporal costs. When a person performs each task of the artificial intelligence model manually, there is a lot of room for mistakes. For this reason, automatic execution of the linked tasks and automation of the transmission of data and a task result (or context or a context value) between the linked tasks are essential elements in performing tasks for artificial intelligence learning.

Meanwhile, with the development of cloud and data center industries, an auto scaling technique capable of increasing and reducing computing resources as needed has emerged. For tasks which are not dependent on a computing resource, it has become a trend to maximize task efficiency by increasing the computing resource as needed, that is, by processing the tasks in parallel. Pipeline-type workloads have been processed from start to finish in one computing resource only in consideration of the specificity of the dependent relationship between workloads. This means that because workloads are not dependent in relationship, a time resource is wasted even in a situation where the workloads are capable of being executed independently. For example, data preprocessing and model quantization may be performed independently. However, a conventional manner in which the data preprocessing and the model quantization are processed in a single computing resource without independent execution causes a situation in which the data preprocessing or the model quantization is pending until any other task ends.

The background art is provided to facilitate better understanding of the present disclosure. It should not be construed that the matters described in the background art are acknowledged as existing in the prior art.

A configuration of a control flow which makes it possible to perform any other task depending on a result of a detailed task of a small unit is an essential element in an automation task for performing tasks of the artificial intelligence model. The control flow is used to enable the execution of any other task depending on a result of a previous task. An existing pipeline system may also specify and use a condition for making the control flow, which may cause a semantic error. Herein, the “semantic error” means an error in which an operation is performed differently from the intention.

Referencing an undefined variable is a representative example of the semantic error. The error is often caused by simple typos when conditions are specified. However, the error is also caused when a variable is referenced without proper consideration of the dependency between tasks. For example, it is assumed the case where the dependent relationship in which task A is first performed and then task B is performed exists between tasks. A situation where task A attempts to refer to variable “x” exposed in task B is a situation where variable “x” is incapable of being referenced; in this case, the execution of the pipeline is impossible. In this case, conventional solutions are interrupted during execution or perform an undefined behavior, leading to an incorrect execution result.

In other words, a high-cost work flow of the artificial intelligence model may be defeated, and the work flow should be executed again from start. That is, the efficiency of a development work of the artificial intelligence model may be significantly reduced. Also, a faulty artificial intelligence model may be exposed to the user.

Additionally, because a task such as data preprocessing often deals with sensitive information, the task sometimes has a constraint that the task should be performed only in a specific computing resource pool. In this situation, all other tasks use the corresponding specific computing resource. This means that the inefficiency issue occurs. That is, the pipeline-type workloads have the inefficiency issue due to serial processing of tasks.

Accordingly, the inventors of the present disclosure have developed a method of specifying the details of detailed tasks of several small units organically connected, which is required to develop an artificial intelligence model, a method of automatically performing the corresponding detailed tasks through the corresponding specification, a method of automatically verifying, through the method, whether a control flow condition specified by an engineer does not cause an error, and a system performing the same.

Accordingly, an object of embodiments is to provide a method for task scheduling and verification for an artificial intelligence model and a device performing the same.

Problems to be solved by the present disclosure are not limited to the above problems, and other problems not mentioned herein may be clearly understood from the specification and the accompanying drawings by one skilled in the art to which the present disclosure pertains.

### SUMMARY

According to an embodiment, a method for task scheduling and verification for an artificial intelligence model, which is performed by a processor, may include generating a task graph for a first pipeline of the artificial intelligence model, the task graph including a plurality of nodes and at least one edge, verifying the task graph, based on the plurality of nodes and the at least one edge, scheduling at least one first workload corresponding to a non-dependent node by using a topological sort algorithm, when the task graph is verified, executing the at least one first workload, scheduling at least one second workload corresponding to a node where dependency with the at least one first workload is released, executing the at least one second workload, and deploying the artificial intelligence model to a user device when all of a plurality of workloads corresponding to the plurality of nodes included in the task graph are performed.

According to an aspect of the present disclosure, the verifying of the task graph may include determining whether the task graph is a directed acyclic graph (DAG), by using a breadth-first search algorithm.

According to another aspect of the present disclosure, the verifying of the task graph may include determining whether a variable to be referenced by one of the plurality of nodes is a variable capable of being referenced, based on the at least one edge.

According to another aspect of the present disclosure, the at least one edge may indicate a dependency relationship between workloads and is marked by a line having directivity between nodes.

According to another aspect of the present disclosure, the plurality of nodes may include information about at least one variable used in the first pipeline or information about workload execution specifications, which is received from the user device.

According to another aspect of the present disclosure, the method may further include transmitting a task result of at least one workload among the plurality of workloads and a software development kit (SDK) code corresponding to on the task result to the at least one of the plurality of workloads.

According to another aspect of the present disclosure, one of the plurality of nodes may be a node which generates a control flow, and the node generating the control flow may generate the control flow by using a task result received from a node on which the node generating the control flow depends.

According to another aspect of the present disclosure, one of the plurality of nodes may be a node which allows a second pipeline to be performed, and the node which allows the second pipeline to be performed may transmit, to the second pipeline, a task result generated from the node which allows the second pipeline to be performed.

According to another aspect of the present disclosure, the method may further include providing the user device with a user interface on which the task graph is displayed.

According to an embodiment, a computing device for task scheduling and verification for an artificial intelligence model may include a memory, a transceiver that receives information about at least one variable used in a first pipeline or information about workload execution specifications from a user device, and at least one processor for artificial intelligence calculation. The processor may generate a task graph for the first pipeline of the artificial intelligence model, the task graph including a plurality of nodes and at least one edge, may verify the task graph, based on the plurality of nodes and the at least one edge, may schedule at least one first workload corresponding to a non-dependent node by using a topological sort algorithm, when the task graph is verified, may execute the at least one first workload, may schedule at least one second workload corresponding to a node where dependency with the at least one first workload is released, may execute the at least one second workload, and may deploy the artificial intelligence model to the user device when all of a plurality of workloads corresponding to the plurality of nodes included in the task graph are performed.

According to an embodiment, a computer program stored in a non-transitory computer-readable recording medium coupled to a computer being hardware to perform the method for task scheduling and verification for the artificial intelligence model described above.

According to an embodiment, a non-transitory computer-readable recording medium may has recorded thereon a computer program executing a method for task scheduling and verification for an artificial intelligence model. The method may include generating a task graph for a first pipeline of the artificial intelligence model, the task graph including a plurality of nodes and at least one edge, verifying the task graph, based on the plurality of nodes and the at least one edge, scheduling at least one first workload corresponding to a non-dependent node by using a topological sort algorithm, when the task graph is verified, executing the at least one first workload, scheduling at least one second workload corresponding to a node where dependency with the at least one first workload is released, executing the at least one second workload, and deploying the artificial intelligence model to a user device when all of a plurality of workloads corresponding to the plurality of nodes included in the task graph are performed.

The solutions of the present disclosure are not limited to the above-described solutions, and solutions that are not mentioned will be clearly understood by those skilled in the art to which the present disclosure pertains from the present specification and the accompanying drawings.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings.

FIG. 1 is a conceptual diagram illustrating an AI system for task scheduling and verification for an artificial intelligence model, according to an embodiment of the present disclosure.

FIG. 2 is a block diagram illustrating a configuration of a server system for task scheduling and verification for an artificial intelligence model, according to an embodiment of the present disclosure.

FIG. 3 is a flowchart for describing a machine learning pipeline according to an embodiment of the present disclosure.

FIG. 4 is a flowchart illustrating a task scheduling and task execution process of an artificial intelligence model using a task graph, according to an embodiment of the present disclosure.

FIG. 5 is a conceptual diagram illustrating a process of verifying a variable capable of being referenced by a node included in a task graph, according to an embodiment of the present disclosure.

FIG. 6 is a conceptual diagram illustrating a task scheduling and execution process according to an embodiment of the present disclosure.

FIG. 7 is a screen illustrating a user interface on which a task graph is displayed, according to an embodiment of the present disclosure.

FIG. 8 is a flowchart illustrating a task scheduling and verification method for an artificial intelligence model, which is performed by a processor, according to an embodiment of the present disclosure.

### DETAILED DESCRIPTION

Specific structural or functional descriptions which are described in the specification in association with various embodiments according to the present disclosure are provided only for the purpose of describing embodiments according to the present disclosure, and the embodiments according to the present disclosure may be carried out in various different forms, not limiting the embodiments described in the specification.

Because the embodiments according to the present disclosure are susceptible to various modifications and alternative forms, the embodiments will be shown as an example in the drawings and will be described in detail in the specification. However, the embodiments according to the present disclosure include modifications, equivalents, and alternatives falling within the spirit and scope of the present disclosure, not limiting the embodiments according to the present disclosure to particular forms disclosed herein.

Even though the terms “first”, “second”, etc. may be used to describe various components, the components should not be construed as being limited by the terms. These terms are only used to distinguish one element from another. For example, a first element may be termed a second element, and, similarly, the second element may be termed the first element, without departing from the scope of the present disclosure.

It should be understood that when a first component is referred to as being “connected” or “coupled” to a second component, the first component may be directly connected or coupled to the second component or intervening components may be present therebetween. In contrast, when an element is referred to as being “directly connected” or “directly coupled” to another element, it should be understood that any other element is not interposed therebetween. Expressions used to describe relationships between components, for example, “between” versus “directly between”, “adjacent” versus “directly adjacent,” etc. should be interpreted in a like fashion.

The terms used herein are only to describe specific embodiments and are not intended to limit the present disclosure. The articles “a”, “an”, and “the” are singular in that they have a single referent, but the use of the singular form should not preclude the presence of more than one referent. In the specification, it should be understood that the terms “comprises”, “comprising”, “includes”, “including”, etc. specify that described features, numbers, steps, operations, components, and parts or a combination thereof exists, but do not preclude the presence or addition of one or more other features, numbers, steps, operations, components, and parts or a combination thereof.

Unless otherwise defined, all terms including technical and scientific terms used herein have the same meaning as commonly understood by one of ordinary skill in the art to which the present disclosure pertains. It will be further understood that terms defined in commonly used dictionaries should be interpreted as having a meaning consistent with their meaning in the context of the related art and will not be interpreted in an idealized or overly formal sense unless expressly so defined herein.

For clarity of interpretation of the specification, the terms used herein will be defined below.

The term “AI system” used herein refers to an AI system for task scheduling and verification. The AI system includes a server system which collects and processes data, trains an artificial intelligence model, infers depending on a request of the user, manages a version of the artificial intelligence model, deploys the artificial intelligence model, evaluates the artificial intelligence model, and builds a pipeline for re-learning, etc., that is, is responsible from the generation of the artificial intelligence model to post-deployment management.

The term “pipeline” used herein refers to an AI pipeline for the development and operations of the artificial intelligence model, and refers to a workflow which connects a series of task processes from data processing to learning, evaluating, and deployment of the artificial intelligence model, for each stage. As an example, an arbitrary pipeline may be a Machine Learning Operations (MLOps) pipeline for model operation automation. The MLOps pipeline is a workflow which connects tasks, such as data collection, preprocessing, model learning, model verification, model save, and model management, CI (Continuous Integration)/CD (Continuous Delivery/Continuous Deployment), deployment, and monitoring, for each stage. The term “task” used herein refers to a task included in an arbitrary pipeline. The “task” may be used in the same sense as the “workload” and corresponds to a “node” of a “task graph”. As an example, an arbitrary task may be data preprocessing, artificial intelligence model quantization, model deployment, etc.

The term “task graph” used herein means a graph which represents an arbitrary pipeline for task scheduling and verification for the artificial intelligence model by using a node and an edge. The node of the task graph represents workload execution specifications of each task. The edge of the task graph is between a node and a node and represents the dependency relationship between tasks corresponding to two nodes.

The term used in the specification, “AI agent”, refers to a software system which calls an external application programming interface (API) or an external service to automate business tasks. In detail, the AI agent may include a model, a tool, and/or a memory. As a component of the AI agent, the model may be a large language model which actually generates a text or a command. As a component of the AI agent, the tool may be a set of an API or services that can be connected to the model to perform various functions such as database inquiry, word processing, and/or customer query response. As a component of the AI agent, the memory stores a history or state in which the model uses the tool and/or a history or state in which the model generates an answer.

The term used in the specification, “pseudo-code”, refers to a code form which is defined to be easily read by a person to explain an algorithm or logic without following the grammar of an actual programming language.

The term used in the specification, “executable code”, refers to a program which is implemented with instructions actually executable by a computer through interpretation or compiling. For example, a code written in languages such as Python, JavaScript, C++, and Java may be the executable code.

The term used in the specification, “processor”, may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

The term used in the specification, “processor”, may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

Below, embodiments will be described in detail with reference to the accompanying drawings. However, the scope of the patent application is neither limited nor restricted by the embodiments. The same reference numerals/signs in the drawings denote the same members.

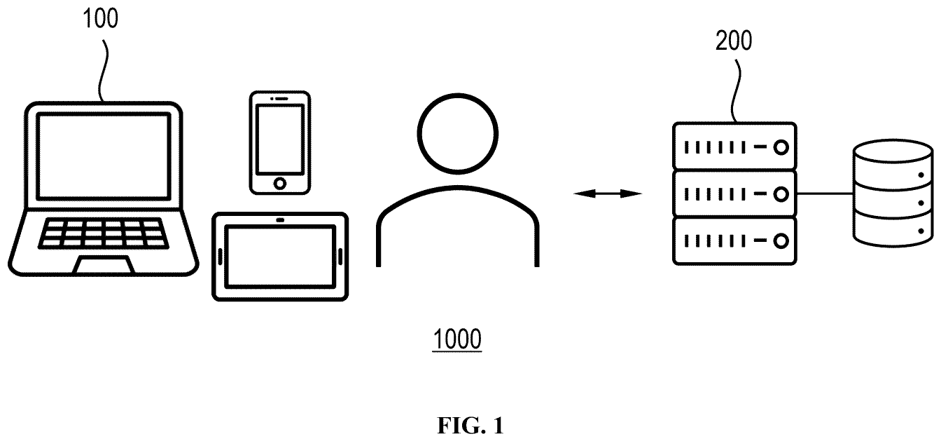

FIG. 1 is a conceptual diagram illustrating an AI system for task scheduling and verification for an artificial intelligence model, according to an embodiment of the present disclosure.

Referring to FIG. 1, an AI system 1000 for task scheduling and verification for an artificial intelligence model, according to an embodiment of the present disclosure, may include a user device 100 and/or a server system 200. As an example, the AI system 1000 may finely tune the artificial intelligence model depending on a request of the user. Depending on a request of the user, the AI system 1000 may verify and/or evaluate whether the artificial intelligence model is well generated to coincide with the request of the user.

The user device 100 may be implemented in a personal computer (PC), a server, or a portable device. The portable device may be implemented with a laptop computer, a mobile phone, a smartphone, a tablet PC, a Mobile Internet Device (MID), a Personal Digital Assistant (PDA), an Enterprise Digital Assistant (EDA), a Digital Still Camera (DSC), a digital video camera, a Portable Multimedia Player (PMP), a Personal Navigation Device or Portable Navigation Device (PND), a handheld game console, an e-book, or a smart device. The smart device may be implemented with a smart watch, a smart band, or a smart ring.

The user device 100 refers to a device of the user which intends to request an artificial intelligence model, which is tuned to be available by a customer, from the server system 200 and to request the verification of the artificial intelligence model. The user device 100 may include a smartphone, a tablet personal computer (PC), a notebook, a PC, etc. Herein, the user of the user device 100 refers to a developer, which develops the artificial intelligence model by using the server system 200, an administrator, etc. The customer refers to a person which buys or uses the artificial intelligence model which the user of the user device 100 develops. The user device 100 may install or execute at least one or more of a web, a mobile application, and a program which the server system 200 provides for task scheduling and verification operations for the artificial intelligence model. For example, the user device 100 may connect to a web page and may output a user interface screen including various components that allow user to write or revise a task graph. The task graph means a graph which represents an arbitrary pipeline for task scheduling and verification for the artificial intelligence model by using a node and an edge.

The server system 200 may be implemented with a printed circuit board (PCB) such as a motherboard, an integrated circuit (IC), or a system on chip (SoC). For example, the server system 200 may be implemented with an application processor (AP).

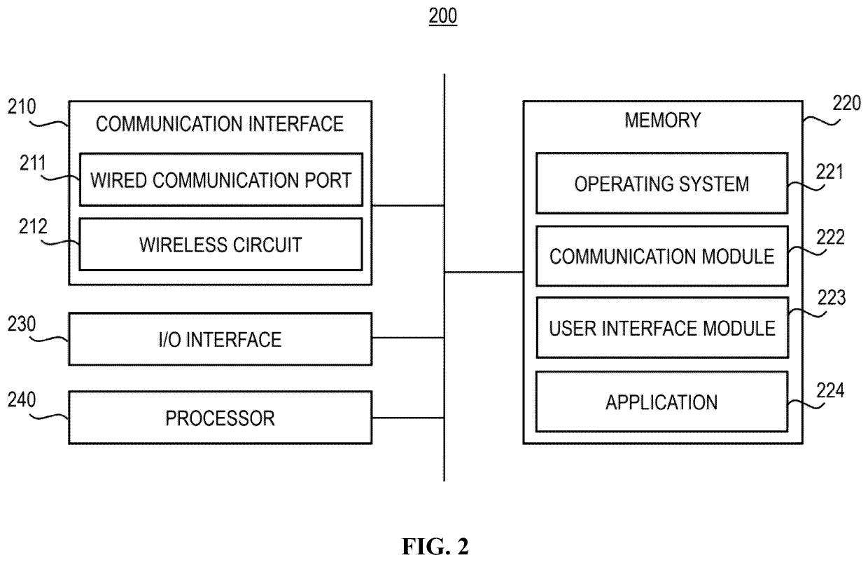

The server system 200 may be a server of a service provider for developing and operating the artificial intelligence model which performs an arbitrary request of the customer. The server system 200 may include a general purpose computer, a laptop, and/or a data server. To provide a task scheduling and verification service of the artificial intelligence model to the user such that the customer is capable of finally using the artificial intelligence model, the server system 200 may provide the user device 100 with one or more of the web, the mobile application, and the program. The server system 200 will be described in detail with reference to FIG. 2.

The artificial intelligence model according to an embodiment of the present disclosure may be a machine learning model or a large language model (LLM). The artificial intelligence model may include a convolutional neural network (CNN), a recurrent neural network (RNN), a perceptron, a multilayer perceptron, a feed forward (FF), a radial basis network (RBF), a deep feed forward (DFF), a long short term memory (LSTM), a gated recurrent unit (GRU), an auto encoder (AE), a variational auto encoder (VAE), a denoising auto encoder (DAE), a parse auto encoder (SAE), a markov chain (MC), a hopfield network (HN), a boltzmann machine (BM), a restricted boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a kohonen network (KN), and/or an attention network (AN). However, it may be understood by an engineer skilled in the art that the artificial intelligence model includes an arbitrary artificial intelligence model without being limited to the above examples.

The AI system 1000 for task scheduling and verification for the artificial intelligence model according to an embodiment of the present disclosure is generally described above.

According to embodiments of the present disclosure, as verification automation of the artificial intelligence model is implemented, it may be possible to prevent (or eliminate) mistakes capable of occurring while a person manually performs a task, as many as possible, through a static analysis and thus, the stability of the artificial intelligence model may be improved.

According to embodiments of the present disclosure, as tasks of the artificial intelligence model, which are capable of being performed in parallel, are performed in parallel as many as possible, the time taken to perform all the tasks necessary to develop the artificial intelligence model may be minimized, and thus, the entire efficiency of the process may be increased.

According to embodiments of the present disclosure, a web interface which the developer or the user is capable of easily using may be provided when the developer or the user performs tasks necessary to develop the artificial intelligence model, and thus, a version control may be possible by using the YAML (YAML Ain't Markup Language) code.

FIG. 2 is a block diagram illustrating a configuration of a server system for task scheduling and verification for an artificial intelligence model, according to an embodiment of the present disclosure.

Referring to FIG. 2, the server system 200 may be a server which provides a service for scheduling and verifying tasks of the artificial intelligence model depending on a request of the user or the user device 100 or may be a computing device on which one or more of a web page, an application, and a program capable of performing a specific process for development and operations of the artificial intelligence model are installed and executed. The server system 200 may include various kinds of servers for developing and/or operating the artificial intelligence model, such as a data processing server, a training server, an inference server, a model management server, and/or a data pipeline server.

The server system 200 may include a communication interface 210, a memory 220, an input/output (I/O) interface 230, and/or a processor 240, which communicate with each other through one or more communication buses or signal lines.

The communication interface 210 may be connected to the user device 100 over a wired/wireless communication network to exchange data. For example, the communication interface 210 may receive an inference request using the artificial intelligence model, a verification request for the artificial intelligence model, an evaluation request for the artificial intelligence model, and a fine-tuning request for the artificial intelligence model from the user device 100.

Meanwhile, the communication interface 210 which enables the transmission/reception of data may include a wired communication port 211 and a wireless circuit 212. Herein, the wired communication port 211 may include one or more wired interfaces, for example, Ethernet, universal serial bus (USB), IEEE1394 (e.g., FireWire of Apple, i.Link of Sonny, or Lynx of Texas Instrument), etc. Also, the wireless circuit 212 may transmit/receive data to/from an external device through a radio frequency (RF) signal or an optical signal. Furthermore, the wireless communication may use at least one of a plurality of communication standards, protocols, and technologies, for example, global system for mobile communications (GSM), enhanced data rates for GSM evolution (EDGE), code-division multiple access (CDMA), time division multiple access (TDMA), Bluetooth, Wi-Fi, VoIP, Wi-MAX, and any other appropriate communication protocol.

The memory 220 may store a variety of data which are used in the server system 200. For example, the memory 220 may store the artificial intelligence model. For another example, the memory 220 may store information necessary to train the artificial intelligence model according to an embodiment of the present disclosure and to infer a result. Also, the memory 220 may store information necessary to verify and/or evaluate the artificial intelligence model.

In various embodiments, the memory 220 may include a volatile or nonvolatile recording medium capable of storing various kinds of data, commands, and/or information. For example, the memory 220 may include a storage medium of at least one type of the following types: a flash memory type, a hard disk type, a multimedia card micro type, a card type memory (e.g., an SD or XD memory), a random access memory (RAM), a static RAM (SRAM), a read-only memory (ROM), a programmable ROM (PROM), an electrically erasable programmable ROM (EEPROM), network storage, cloud, and a blockchain database.

In various embodiments, the memory 220 may store at least one of an operating system 221, a communication module 222, a user interface module 123, and one or more applications 224.

The operating system 221 (e.g., an embedded operating system such as LINUX, UNIX, MAC OS, WINDOWS, or VxWorks) may include various software components and drivers for controlling and managing general system tasks (e.g., memory management, storage device control, and power management) and may support communication between various hardware, firmware, and software components.

The communication module 222 may support communication with any other device through the communication interface 210. The communication module 222 may include various software components for processing data received by the wired communication port 211 or the wireless circuit 212 of the communication interface 210.

The user interface module 223 may receive a request or an input of the user from a keyboard, a touchscreen, a keyboard, a mouse, and/or a microphone through the I/O interface 230 and may provide a user interface on a display.

An application 224 may include a program or a module which is configured to be executable by one or more processors 240. Herein, an application which provides a task scheduling and verification service for processing all processes necessary to train the artificial intelligence model, to generate the task graph, to schedule workloads, and/or to execute workloads may be implemented on a server farm.

The I/O interface 230 may connect an input/output device (not illustrated) of the server system 200, for example, at least one of a display, a keyboard, a touchscreen, and a microphone with a user interface module 223. The I/O interface 230 may receive a user input (e.g., a voice input, a keyboard input, or a touch input) together with the user interface module 223 and may process a command according to the received input.

The processor 240 may be connected to the communication interface 210, the memory 220, and the I/O interface 230 to control all operations of the server system 200 and may perform various commands for task scheduling and verification through the application and/or the program stored in the memory 220.

The processor 240 may correspond to a computing device such as a central processing unit (CPU) or an application processor (AP). Also, the processor 140 may be implemented in the form of an integrated chip (IC) such as a system on chip (SoC) in which various computing devices are integrated. In addition, the processor 140 may include a module for calculating an artificial neural network model such as a neural processing unit (NPU).

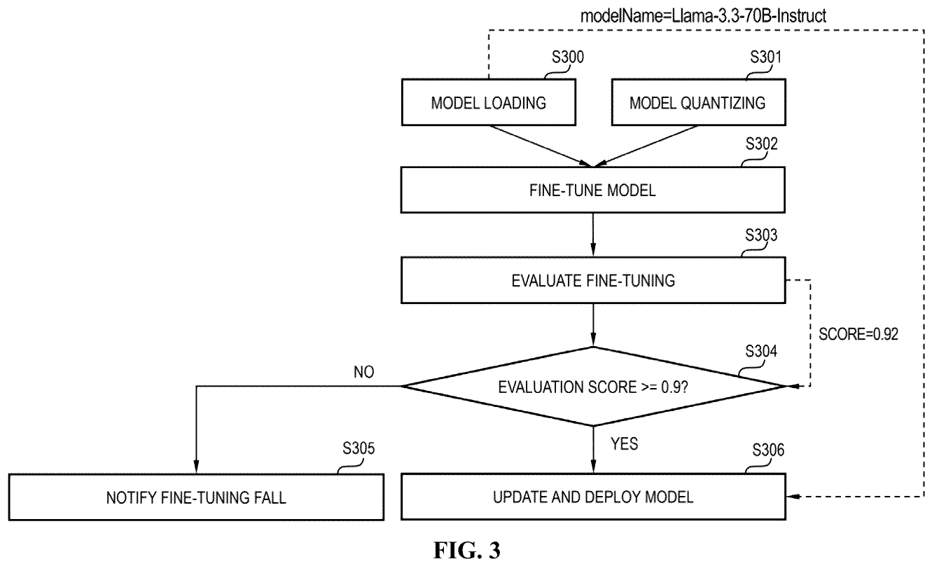

FIG. 3 is a flowchart for describing a machine learning pipeline according to an embodiment of the present disclosure.

In FIG. 3, each step expressed in the shape of a rectangle or a rhombus means one workload. A solid arrow indicates the dependency relationship between tasks (or workloads), and a dotted arrow indicates a transmission flow of a task result.

In the specification, a “non-dependent node” refers to a node in which there is no case where an arrow faces the corresponding node. A “dependent node” means a node in which there is at least one case where an arrow faces the corresponding node. In FIG. 3, “model loading” and “model quantizing” are non-dependent nodes, and the remaining nodes are dependent nodes.

In the specification, a “node dependent on a first workload (or a first node)” refers to a node which is connected to the first workload by the solid arrow and is dependent on a task result of the first workload. For example, a node which is dependent on a workload loading a model is a workload which fine-tunes the model. In contrast, a “node which a second workload (or a second node) depends on” means a node which is connected to the second workload by the solid arrow and transmits a task result to the second workload. The second workload refers to a node which depends on the task result of the “node which the second workload depends on”. For example, the node which the workload fine-tuning the model depends on is a workload which loads the model.

Referring to FIG. 3, the server system 200 according to an embodiment of the present disclosure may load the artificial intelligence model (S300). In other words, the server system 200 may prepare a state of loading the stored artificial intelligence model file or data (e.g., trained weights, and the architecture of the artificial intelligence model) to a memory so as to be executable. A task result of the workload corresponding to the model loading, for example, a name modelName (=Llama−3.3×70B−Instruct) of the artificial intelligence model may be transmitted to a workload for uploading and deploying the artificial intelligence model.

The server system 200 according to an embodiment of the present disclosure may quantize the artificial intelligence model (S301). Step S300 where the artificial intelligence model is loaded and step S301 do not depend on each other. Accordingly, step S301 may be simultaneously performed in parallel with step S300.

When the artificial intelligence model loading and the artificial intelligence model quantizing are completed, the server system 200 according to an embodiment of the present disclosure may fine-tune the artificial intelligence model (S302).

When the artificial intelligence model tuning is completed, the server system 200 according to an embodiment of the present disclosure may evaluate the fine-tuning (S303). As an example, the server system 200 may evaluate whether an equation or a reference for evaluating the stability of the fine-tuned artificial intelligence model is appropriately set and may calculate an evaluation result as an evaluation score. The task result of the workload corresponding to the fine-tuning evaluation, for example, the evaluation score of 0.92 (score=0.92) may be transmitted to a workload for determining the evaluation score.

When the fine-tuning evaluation of the artificial intelligence model is completed, the server system 200 according to an embodiment of the present disclosure may determine whether the evaluation result is 0.9 or more (S304). Herein, an embodiment in which the reference of determination is 0.9 is provided only as an example, and in some cases, a reference score may be variously set.

When the determination result at step S304 indicates that the evaluation score is smaller than 0.9 (No at step S304), the server system 200 according to an embodiment of the present disclosure may notify the user device 100 that the fine-tuning is failed (S305).

When the determination result at step S304 indicates that the evaluation score is 0.9 or more (Yes at step S304), the server system 200 according to an embodiment of the present disclosure may upload and deploy the artificial intelligence model (S306).

As described above, organically linked tasks are required to allow the customer to finally use the artificial intelligence model. According to embodiments of the present disclosure, the linked tasks may be automatically performed, tasks capable of being performed independently or in parallel may be allocated to an available computing resource in parallel so as to be performed thereby, and transmission of data and task result between the linked tasks may be automated.

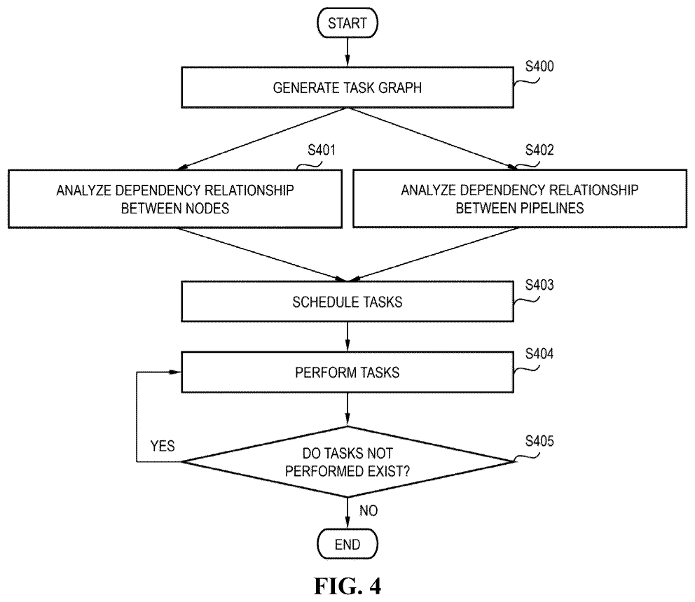

FIG. 4 is a flowchart illustrating a task scheduling and task execution process of an artificial intelligence model using a task graph, according to an embodiment of the present disclosure.

The server system 200 according to an embodiment of the present disclosure may generate a task graph for a specific pipeline (S400).

At least one task may be included in the specific pipeline. The specific pipeline means a pipeline determined by a request of the user as an execution target. The user may define (or specify) execution specifications of a workload and may define (or specify) variables to be used throughout the specific pipeline, by using a predetermined YAML (YAML Ain't Markup Language) structure or web interface.

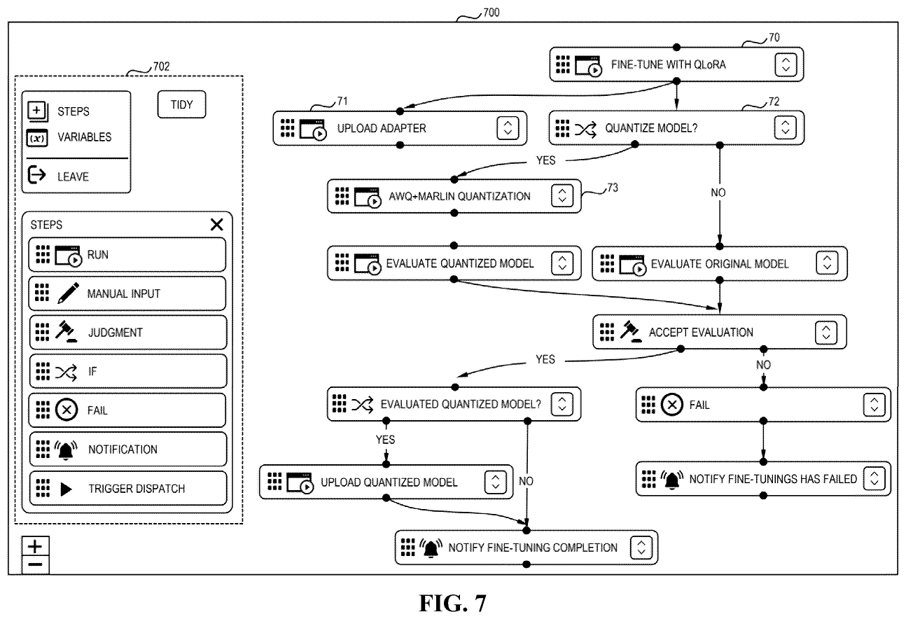

A node may mean a workload corresponding to one task for the artificial intelligence model and may be marked by a rectangle on the task graph. An edge may represent the dependency relationship between tasks (or workloads) and may be marked by a solid arrow on the task graph. An example of the task graph will be described in detail with reference to FIG. 7.

The execution specifications of the workload defined by the user may be marked by a node, and the dependency relationship between workloads may be marked by an edge having directivity between nodes. It is assumed that an arrow starts from task A and ends at task B (A→B). This assumption means that a workload of task B is capable of being executed after a workload corresponding to task A has to be ended. The workload corresponding to task B may be provided with the task result of task A in the form of an environment variable or a sub-directory, and the task result of task A may be specified in the execution specifications of the workload corresponding to task B.

In an embodiment, a first node may be a node which generates a control flow. The node which generates the control flow may generate the control flow by using a task result which is received from a node on which the node generating the control flow depends.

In an embodiment, when the final confirmation of the user is required (Human-in-the-loop), the user may define the execution specifications enabling the final confirmation, by configuring or adding a separate node for the corresponding task.

The server system 200 according to an embodiment of the present disclosure may analyze the dependency relationship between nodes (S401).

Also, the server system 200 according to an embodiment of the present disclosure may analyze the dependency relationship between pipelines (S402). In other words, the server system 200 may analyze the dependency relationship between the specific pipeline determined by the user as an execution target and another pipeline.

In an embodiment, a second node may be a node which allows a pipeline, which is different from the specific pipeline determined by the user as an execution target, to be performed. Herein, the specific pipeline determined by the user as an execution target may be referred to as a “first pipeline”, and a pipeline different from the specific pipeline determined by the user as an execution target may be referred to as a “second pipeline”. That is, the second node may be a node which allows the second pipeline to be performed. The server system 200 may specify variables to be transmitted as a task result to the second pipeline. For example, the server system 200 may transmit an output, a pipeline variable, and/or a constant exposed at the second node to the second pipeline. When the execution of the first pipeline and the second pipeline is infinitely repeated due to the mutual call, for example, when a cycle is generated between pipelines in a manner where the second pipeline under call calls the first pipeline corresponding to an original pipeline, the server system 200 may reject the generation of the pipeline through a static analysis.

The completed task graph should not be an infinite loop or an inexecutable graph. That is, the task graph may be a DAG (Directed Acyclic Graph) including an edge. The server system 200 may verify whether the task graph is the DAG, by utilizing a breadth-first search (BFS) algorithm.

The server system 200 according to an embodiment of the present disclosure may verify whether a variable to which an arbitrary node refers is a variable capable of being referenced. In detail, the server system 200 may verify whether a variable to which an arbitrary node refers is a variable capable of being referenced, depending on the cause-and-effect relationship or dependency relationship between workloads.

In an embodiment, the server system 200 may verify whether a variable to which an arbitrary node refers is a variable capable of being referenced, based on a scope of an arbitrary node, an argument scope, and/or definition of a task result. The scope of an arbitrary node may mean a set of character strings or logical subdirectories exposed to any other node as an execution result of the corresponding node. For example, when any other node intends to utilize data exposed as a task result of task A, such as a variable of “result” and a subdirectory of “data”, the scope of task A may be defined as {result, /data}. The argument scope may mean a set of a logical subdirectory and a variable injected from the outside during the execution of a task included in a pipeline. A task result (or context) of an arbitrary node may be a union of the scope of previous nodes of the corresponding node and an argument scope. The previous nodes of the corresponding node refer to nodes which should be necessarily executed prior to the corresponding node. As an example, when node X should be necessarily executed prior to node A due to the cause-and-effect relationship, node X corresponds to the previous node of node A. As an example, assuming the cause-and-effect relationship of A→B→C, a task result of C may be defined as a union of a scope of node A, a scope of node B, and an argument scope.

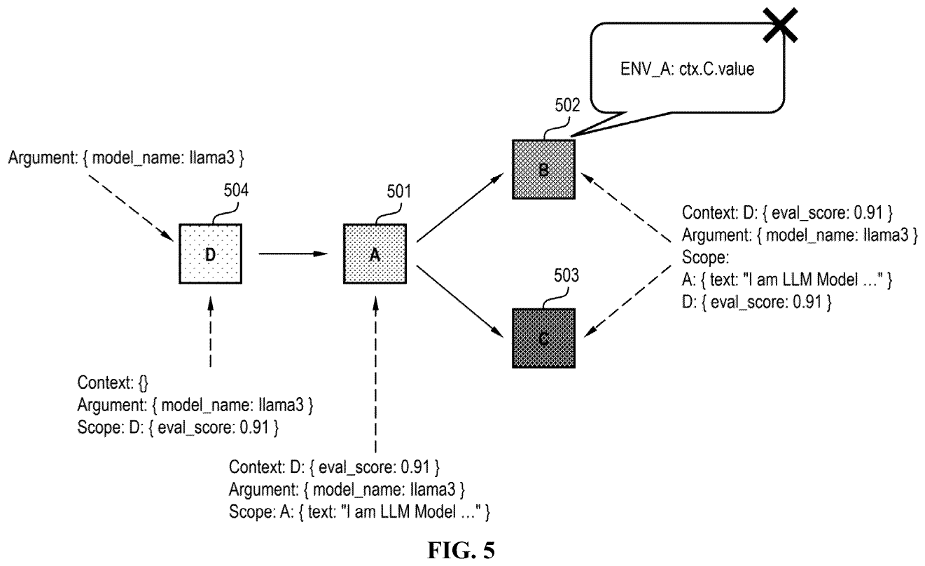

In another embodiment, the server system 200 may execute a topological sort algorithm on the task graph and may verify whether a variable to which an arbitrary node refers is a variable capable of being referenced, and the verification may be performed in a manner where the server system 200 performs simulation from the non-dependent node until the last task is completed. For example, referring to FIG. 5, it is assumed the case of verifying a variable which is capable of being referenced from node 501 corresponding to task A.

The server system may determine whether a variable or a logical subdirectory to which task A refers exists is present in the context of task A; when the variable or the logical subdirectory does not exist, the server system 200 may reject the corresponding variable or logical subdirectory. Node 502 corresponding to task B may refer to results of tasks which should be performed before task B and may use the results to drive a workload. When node 502 corresponding to task B refers to a variable of node 503 corresponding to task C having no cause-and-effect relationship or dependency relationship with task B, the server system 200 may reject the corresponding variable. The server system 200 may generate a new task result including both the task result of task A and the scope which is generated after the execution of task A is terminated. A task result newly generated in association with task A may be defined as “C'”. In association with a node depending on task A, for example, node 502 corresponding to task B, the server system 200 may newly generate or update the task result of task B, including both a task result Ctx(B) of the corresponding node 502 and a task result generated in a previous phase of the corresponding node 502

Returning to FIG. 4, the specifications of at least one task included in the specific pipeline can be a specifications capable of being executed, through deployment. After the deployment, the corresponding specification may be set to be incapable of being edited by the user. This is to prevent the sudden change in the specifications when a task being performed based on the corresponding specification exists.

The server system 200 according to an embodiment of the present disclosure may schedule tasks (S403) and may perform the scheduled tasks (S404).

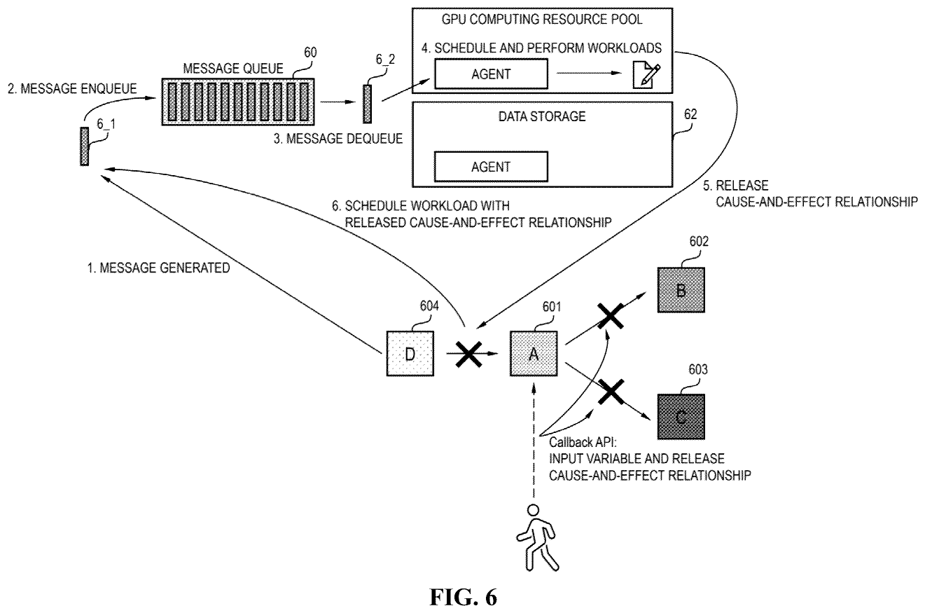

In association with all non-dependent nodes, the server system 200 may schedule workloads respectively corresponding to the non-dependent nodes. Referring to FIG. 6, for example, the scheduling of node 604 corresponding to task D may be performed in a manner of issuing a message 6_1 by using a message queue 60. The server system 200 may check a schedule message 6_2 dequeued from the message queue 60 depending on the priority of the message queue 60 and may request task execution from a computing resource pool determined depending on workload specifications defined in the schedule message 6_2. Depending on the task execution request, the corresponding task may be scheduled and performed to a computing resource through an execution agent present in the computing resource pool.

The workload being performed may designate a result value of the workload to be exposed through the scope of a node after the corresponding task, through the SDK (Software Development Kit) code. The SDK code may be designated as a pair of key and value and may be applied to the node scope implemented in the form of a dictionary. In the case of exposing a task result in the form of a subdirectory, the server system 200 may back the task result up to data storage 62 connected to the server system 200 as soon as a workload being performed is terminated and may transfer an output in a manner where a workload downloads the corresponding backup.

In an embodiment, the server system 200 may perform the topological sort algorithm to schedule tasks. As an example, after the execution of the workload corresponding to task D is terminated, the server system 200 may release the entire cause-and-effect relationship starting from node 604 corresponding to task D. As such, when a node which does not depend on a specific node (e.g., node 604 corresponding to task D), that is, a node (e.g., node 601 corresponding to task A) where the dependency with the specific node is released occurs, the server system 200 may schedule a workload corresponding to the node thus occurred.

In an embodiment, in a task in which the description is given as confirmation or an input value of the user is required, the server system 200 may stop the control flow and may switch a state of the corresponding node to an “AWAITING_INPUT” state. As an example, when a task in which the description is given as confirmation or an input value of the user is required is node 601 corresponding to task A, the user may input a variable necessary for the corresponding task by using an HTTP Callback API capable of switching the corresponding state. The variable input through the HTTP Callback API may be included in a task result of the node 601; like the case of another node, the server system 200 may perform the topological sort algorithm on task A and may continuously perform a workload.

FIG. 7 is a screen illustrating a user interface on which a task graph is displayed, according to an embodiment of the present disclosure.

FIG. 7 is screen 700 showing a user interface which allows the user to generate the task graph while performing tasks necessary to develop the artificial intelligence model.

On screen 700 representing the user interface, a plurality of nodes and edges connecting the plurality of nodes are displayed. Referring to FIG. 7, a first node 70 is a node which is a non-dependent node and performs fine-tuning by using the QLoRA (Quantized Low-Rank Adapter). A second node 71 and a third node 72, which depend on the first node 70, are a node inserting an additional adapter layer and a node quantizing a model, respectively.

Various tools 702 necessary for the user to generate the task graph are also displayed on screen 700 representing the user interface.

According to embodiments, a web interface which is capable of being easily used by the developer or user may be provided to facilitate tasks while performing tasks necessary to develop the artificial intelligence model.

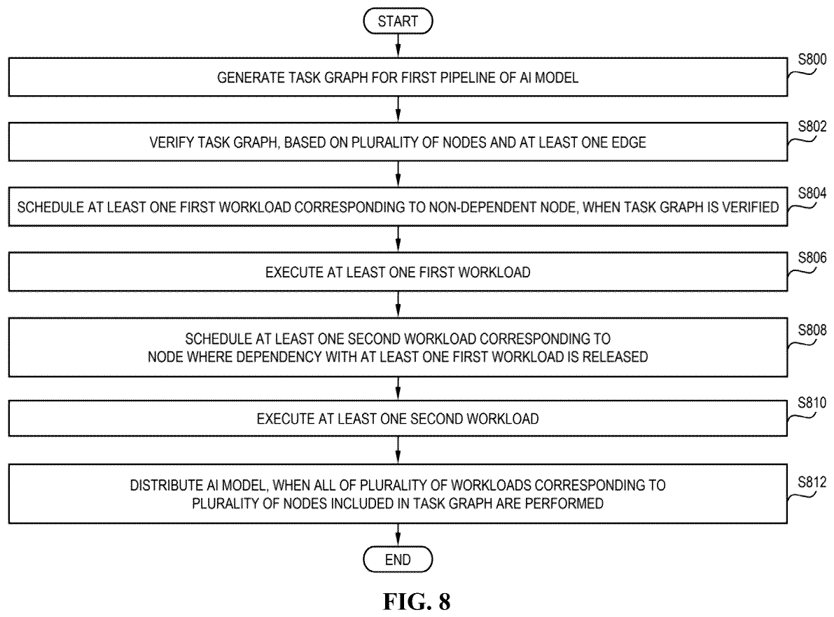

FIG. 8 is a flowchart illustrating a task scheduling and verification method for an artificial intelligence model, which is performed by a processor, according to an embodiment of the present disclosure.

According to a task scheduling and verification method for an artificial intelligence model performed by a processor, according to an embodiment of the present disclosure, the server system 200 may generate a task graph for a first pipeline of the artificial intelligence model (S800). The task graph may include a plurality of nodes and at least one edge.

The at least one edge may indicate the dependency relationship between workloads and may be marked by a line having directivity between nodes.

The plurality of nodes may include information about at least one variable used in the first pipeline or information about execution specifications of a workload, which is received from the user device 100.

According to the task scheduling and verification method for the artificial intelligence model performed by the processor, according to an embodiment of the present disclosure, the server system 200 may transmit a task result of at least one of the plurality of workloads and the SDK (Software Development Kit) code corresponding thereto to a node depending on at least one of the plurality of nodes.

In an embodiment, one of the plurality of nodes is a node which generates a control flow. The node which generates the control flow may generate the control flow by using a task result which is received from a node on which the node generating the control flow depends.

In another embodiment, one of the plurality of nodes is a node which allows a second pipeline to be performed. The node which allows the second pipeline to be performed may transmit, to the second pipeline, a task result which is generated from the node which allows the second pipeline to be performed.

According to the task scheduling and verification method for the artificial intelligence model performed by the processor, according to an embodiment of the present disclosure, the server system 200 may provide the user device 100 with a user interface on which the task graph is displayed.

According to the task scheduling and verification method for the artificial intelligence model performed by the processor, according to an embodiment of the present disclosure, the server system 200 may verify the task graph, based on the plurality of nodes and the at least one edge (S802).

In an embodiment, based on a result of analyzing the dependency relationship between nodes or the dependency relationship between pipelines, the server system 200 may determine whether the task graph is the DGA including an edge, by utilizing the breadth-first search algorithm. Alternatively, based on a result of analyzing the dependency relationship between nodes or the dependency relationship between pipelines, the server system 200 may determine whether a variable which an arbitrary node refers to is a variable capable of being referenced depending on the cause-and-effect relationship or dependency relationship between workloads.

According to the task scheduling and verification method for the artificial intelligence model performed by the processor, according to an embodiment of the present disclosure, when the task graph is verified, the server system 200 may schedule at least one first workload corresponding to the non-dependent node (S804).

According to the task scheduling and verification method for the artificial intelligence model performed by the processor, according to an embodiment of the present disclosure, the server system 200 may execute the at least one first workload (S806).

According to the task scheduling and verification method for the artificial intelligence model performed by the processor, according to an embodiment of the present disclosure, the server system 200 may schedule at least one second workload corresponding to a node wherein the dependency with the at least one first workload is released (S808).

According to the task scheduling and verification method for the artificial intelligence model performed by the processor, according to an embodiment of the present disclosure, the server system 200 may execute the at least one second workload (S810).

According to the task scheduling and verification method for the artificial intelligence model performed by the processor, according to an embodiment of the present disclosure, when all of a plurality of workloads corresponding to the plurality of nodes included in the task graph are performed, the server system 200 may deploy the artificial intelligence model to the user device 100 (S812).

A computing device for task scheduling and verification for an artificial intelligence model, according to an embodiment of the present disclosure, may include a memory, a transceiver configured to receive information about at least one variable used in a first pipeline or information about workload execution specifications from the user device 100, and/or at least one processor for artificial intelligence calculation. The processor may be configured to generate a task graph for the first pipeline of the artificial intelligence model, the task graph including a plurality of nodes and at least one edge, to verify the task graph, based on the plurality of nodes and the at least one edge, to schedule at least one first workload corresponding to a non-dependent node by using a topological sort algorithm, when the task graph is verified, to execute the at least one first workload, to schedule at least one second workload corresponding to a node where dependency with the at least one first workload is released, to execute the at least one second workload, and to deploy the artificial intelligence model to the user device when all of a plurality of workloads corresponding to the plurality of nodes included in the task graph are performed,.

The computing device for task scheduling and verification for the artificial intelligence model may include a computer program which is stored in a computer-readable recording medium coupled to a computer (or a computing device) being hardware and performs step S800 to step S812 of FIG. 8 described above.

The computing device for task scheduling and verification for the artificial intelligence model may be implemented with a computing device including at least one processor which executes instructions of programs loaded to the memory. A program including the instructions described to execute step S800 to step S812 of FIG. 8 described above may be loaded to the memory of the computing device.

The foregoing devices may be implemented by a hardware component, a software component, and/or a combination of a hardware component and a software component. For example, the devices and the components described in the embodiments may be implemented by using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor, or any device which may execute instructions and may respond thereto. A processing unit may execute an operating system (OS) or one or more software applications running on the operating system. Also, the processing unit may access, store, manipulate, process, and generate data in response to the execution of software. For convenience of understanding, the description is given as a single processing unit, but it will be understood by one skilled in the art that the processing unit may include a plurality of processing elements and/or a plurality of types of processing elements. For example, the processing device may include a plurality of processors or may include one processor and one controller. Also, any other processing configuration such as a parallel processor is possible.

Software may include a computer program, a code, an instruction, or one or more combinations thereof and may constitute a processing device to operate in a desired manner or may control the processing device independently or collectively. Software and/or data may be permanently or temporarily embodied in any type of a machine, a component, physical equipment, virtual equipment, a computer storage medium, a computer device or in a transmitted signal wave, so as to be interpreted by the processing unit or to provide instructions or data to the processing unit. Software may be distributed on computer systems connected over a network so as to be stored therein or executed thereon. Software and data may be recorded in one or more computer-readable storage media.

The method according to the embodiment may be recorded in a computer-readable medium including a program instruction executable through various computer devices. The computer-readable medium may also include a program instruction, a data file, a data structure, or a combination thereof. The program instruction recorded in the medium may be designed and configured specially for the embodiment or may be known and available to one skilled in computer software. The computer-readable storage medium may include, for example, a hardware device, which is specially configured to store and execute a program instruction, such as a magnetic medium (e.g., a hard disk drive, a floppy disk or a magnetic tape), an optical medium (e.g.; CD-ROM or DVD), a magneto-optical medium (e.g., a floptical disk), a read only memory (ROM), a random access memory (RAM), or a flash memory. As an example, the program instruction includes not only a machine language code created by a compiler but also a high-level language code capable of being executed by a computer by using an interpreter or the like. The hardware device may be configured to act as one or more software modules to perform the operation of the embodiment, and vice versa.

According to embodiments, as verification automation of the artificial intelligence model is implemented, it may be possible to prevent (or eliminate) mistakes capable of occurring while a person manually performs a task, as many as possible, through a static analysis and thus, the stability of the artificial intelligence model may be improved.

According to embodiments, as tasks of the artificial intelligence model, which are capable of being performed in parallel, are performed in parallel as many as possible, the time taken to perform all the tasks necessary to develop the artificial intelligence model may be minimized, and thus, the entire efficiency of the process may be increased.

According to embodiments, a web interface which the developer or the user is capable of easily using may be provided when the developer or the user performs tasks necessary to develop the artificial intelligence model, and thus, a version control may be possible by using the YAML (YAML Ain't Markup Language) code.

Effects according to the present disclosure are not limited to the above effects, and effects not mentioned herein may be clearly understood from the specification and the accompanying drawings by one skilled in the art to which the present disclosure pertains.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents to the claims fall within the scope of the following claims.

What is claimed is:

1. A method for task scheduling and verification for an artificial intelligence model, which is performed by a processor, the method comprising:
generating a task graph for a first pipeline of the artificial intelligence model, wherein the task graph includes a plurality of nodes and at least one edge;
verifying the task graph, based on the plurality of nodes and the at least one edge;
when the task graph is verified, scheduling at least one first workload corresponding to a non-dependent node by using a topological sort algorithm;
executing the at least one first workload;
scheduling at least one second workload corresponding to a node where dependency with the at least one first workload is released;
executing the at least one second workload; and
when all of a plurality of workloads corresponding to the plurality of nodes included in the task graph are performed, deploying the artificial intelligence model to a user device.

2. The method of claim 1, wherein the verifying of the task graph includes:
determining whether the task graph is a directed acyclic graph (DAG), by using a breadth-first search algorithm.

3. The method of claim 1, wherein the verifying of the task graph includes:
determining whether a variable to be referenced by one of the plurality of nodes is a variable capable of being referenced, based on the at least one edge.

4. The method of claim 1, wherein the at least one edge indicates a dependency relationship between workloads and is marked by a line having directivity between nodes.

5. The method of claim 4, wherein the plurality of nodes include information about at least one variable used in the first pipeline or information about workload execution specifications, which is received from the user device.

6. The method of claim 1, further comprising:
transmitting a task result of at least one workload among the plurality of workloads and a software development kit (SDK) code corresponding to the task result to the at least one of the plurality of workloads.

7. The method of claim 1, wherein one of the plurality of nodes is a node which generates a control flow, and
wherein the node generating the control flow generates the control flow by using a task result received from a node on which the node generating the control flow depends.

8. The method of claim 1, wherein one of the plurality of nodes is a node which allows a second pipeline to be performed, and
wherein the node which allows the second pipeline to be performed transmits, to the second pipeline, a task result generated from the node which allows the second pipeline to be performed.

9. The method of claim 1, further comprising:
providing the user device with a user interface on which the task graph is displayed.

10. A computing device for task scheduling and verification for an artificial intelligence model, comprising:
a memory;
a transceiver configured to receive information about at least one variable used in a first pipeline or information about workload execution specifications from a user device; and
at least one processor for artificial intelligence calculation,
wherein the processor is further configured to:
generate a task graph for the first pipeline of the artificial intelligence model, wherein the task graph includes a plurality of nodes and at least one edge;
verify the task graph, based on the plurality of nodes and the at least one edge;
when the task graph is verified, schedule at least one first workload corresponding to a non-dependent node by using a topological sort algorithm;
execute the at least one first workload;
schedule at least one second workload corresponding to a node where dependency with the at least one first workload is released;
execute the at least one second workload; and
when all of a plurality of workloads corresponding to the plurality of nodes included in the task graph are performed, deploy the artificial intelligence model to the user device.

11. A computer program stored in a non-transitory computer-readable recording medium coupled to a computer being hardware to perform the method for task scheduling and verification for the artificial intelligence model of claim 1.

12. A non-transitory computer-readable recording medium having recorded thereon a computer program for executing a method for task scheduling and verification for an artificial intelligence model, the method comprising:
generating a task graph for a first pipeline of the artificial intelligence model, wherein the task graph includes a plurality of nodes and at least one edge;
verifying the task graph, based on the plurality of nodes and the at least one edge;
when the task graph is verified, scheduling at least one first workload corresponding to a non-dependent node by using a topological sort algorithm;
executing the at least one first workload;
scheduling at least one second workload corresponding to a node where dependency with the at least one first workload is released;
executing the at least one second workload; and
when all of a plurality of workloads corresponding to the plurality of nodes included in the task graph are performed, deploying the artificial intelligence model to a user device.
